(19) United States
(12) Patent Application Publication
(10) Pub. No.: US 2025/0211887 A1
(43) Pub. Date: Jun. 26, 2025

(54) HEAD-MOUNTED DEVICE

(71) Applicant: GOERTEK TECHNOLOGY CO., LTD., Qingdao (CN)

(72) Inventors: Jie ZHANG, Qingdao (CN); Guangpeng TIE, Qingdao (CN)

(21) Appl. No.: 19/078,633

(22) Filed: Mar. 13, 2025

Related U.S. Application Data
(63) Continuation of application No. PCT/CN2023/124758, filed on Oct. 16, 2023.

(30) Foreign Application Priority Data
Oct. 25, 2022 (CN) 202211315437.5

(51) Int. Cl. H04R 1/02; H04R 3/04

(52) U.S. Cl. CPC H04R 1/028; H04R 3/04

(57) ABSTRACT

Disclosed is a head-mounted device, which includes a device body, a wearing portion, a bone conduction microphone and a speaker module. The wearing portion is connected to an end of the device body, the bone conduction microphone is provided at the wearing portion, and the speaker module is provided at the wearing portion. The speaker module includes two speaker units. Each speaker unit includes a magnetic circuit structure, a voice coil and a sound diaphragm. The distribution directions of the two speaker units are parallel to the distribution directions of the magnetic circuit structure and the sound diaphragm of at least one of the speaker units, and vibration directions of the sound diaphragms of the two speaker units are opposite at a first frequency band.

### CROSS-REFERENCE TO RELATED APPLICATIONS

This application is a continuation application of International Application No. PCT/CN2023/124758, filed on Oct. 16, 2023, which claims priority to Chinese Patent Application No. 202211315437.5, filed on Oct. 25, 2022. The disclosures of the above-mentioned applications are incorporated herein by reference in their entireties.

### TECHNICAL FIELD

The present application relates to the technical field of head-mounted devices, and in particular to a head-mounted device.

### BACKGROUND

Head-mounted devices include head-mounted display devices such as virtual reality head-mounted devices, augmented reality head-mounted devices, and mixed reality head-mounted devices, as well as smart glasses, etc., and usually include a device body for realizing the main functions (for smart glasses, that is, the frame), a wearing portion for wearing the device body on the user's head (for smart glasses, that is, the temples), a speaker for sound output, and a microphone for voice input. In existing head-mounted devices, since the sound output of the speaker is likely to cause mechanical vibration of the shell, when the head-mounted device is equipped with a bone conduction microphone, it is easy to cause the voice input by the microphone to be mixed with noise caused by the vibration of the shell.

### SUMMARY

The main purpose of the present application is to provide a head-mounted device, which aims to reduce the intensity of the mechanical vibration of the shell caused by the speaker to improve the voice quality input by the bone conduction microphone.

To achieve the above object, the head-mounted device provided by the present application includes:
a device body;
a wearing portion connected to an end of the device body;
a bone conduction microphone provided at the wearing portion; and
a speaker module provided at the wearing portion.

The speaker module includes two speaker units; each speaker unit includes a magnetic circuit structure, a voice coil and a sound diaphragm; a distribution direction of the two speaker units is parallel to a distribution direction of the magnetic circuit structure and the sound diaphragm of at least one of the speaker units; and vibration directions of the sound diaphragms of the two speaker units are opposite at a first frequency band.

In an embodiment, magnetic circuit directions of the magnetic circuit structures of the two speaker units are opposite, and the voice coils of the two speaker units are passed with in-phase current at the first frequency band.

In an embodiment, the distribution directions of the magnetic circuit structures and the sound diaphragms of the two speaker units are opposite, the distribution directions of the two speaker units are parallel to the distribution direction of the magnetic circuit structure and the sound diaphragm of one of the speaker units, and the sound diaphragms of the two speaker units are respectively provided at opposite sides of the magnetic circuit structures of the two speaker units.

In an embodiment, the wearing portion is provided with two sound guiding channels corresponding to the speaker module; one sound guiding channel corresponds to one speaker unit, is communicated with a front sound cavity of the corresponding speaker unit, and is provided with a sound outlet hole communicated with outside; and the two speaker units and the two sound guiding channels are symmetrical relative to a same symmetry axis.

In an embodiment, the wearing portion includes two side arms respectively connected to two ends of the device body, and one side arm is correspondingly provided with one speaker module.

In an embodiment, the head-mounted device further includes two air conduction microphones respectively provided at an upper side and a lower side of the same side arm.

In an embodiment, the air conduction microphone is provided at a side of the bone conduction microphone close to the device body.

In an embodiment, the first frequency band is a frequency band less than or equal to 300 Hz, and the vibration directions of the sound diaphragms of the two speaker units are identical at a frequency band greater than 300 Hz.

In an embodiment, the head-mounted device further includes an air conduction microphone provided at the wearing portion and a voice control module provided at the device body. The voice control module is configured to perform mixed processing on voice signals of the air conduction microphone and the bone conduction microphone.

In an embodiment, there are multiple air conduction microphones, and the voice control module is configured to perform echo cancellation processing on the voice signal of each air conduction microphone, perform beamforming processing on the voice signals of the multiple air conduction microphones after the echo cancellation processing, perform noise reduction processing on an air conduction voice signal formed after the beamforming processing, and mix the air conduction voice signal after the noise reduction processing with the voice signal of the bone conduction microphone.

In an embodiment, two air conduction microphones are provided, and are respectively provided at an upper side and a lower side of the wearing portion.

In the technical solution of the present application, in any frequency band or full frequency band of the speaker module, the vibration directions of the sound diaphragms of the two speaker units are opposite, which can offset the forces exerted by the sound diaphragms of the two speaker units on the shell, thereby greatly reducing the intensity of mechanical vibration generated by the shell in the corresponding frequency band, which is beneficial for the bone conduction microphone to pick up pure voice signals without environmental noise, so as to improve the voice quality input by the bone conduction microphone. In practical applications, a certain frequency band or the full frequency band of the speaker module can be selected according to needs, so that the vibration directions of the sound diaphragms of the two speaker units are opposite, and the desired effect of improving voice quality can be achieved. In addition, since the sound diaphragms of the two speaker units need to be able to vibrate in opposite directions, the distribution directions of the magnetic circuit structures and the sound diaphragms of the two speaker units need to be the same or opposite. The two speaker units are distributed along the distribution direction of the magnetic circuit structure and the sound diaphragm of at least one speaker unit. This can make the axisymmetry and the sound consistency of the speaker module is better, which is beneficial to improving the sound quality of the speaker module and improving the effect of weakening the vibration of the shell.

### BRIEF DESCRIPTION OF THE DRAWINGS

In order to more clearly illustrate the embodiments of the present application or the technical solutions in the related art, the drawings required for use in the embodiments or the description of the related art will be briefly introduced below. Obviously, the drawings described below are only some embodiments of the present application. For persons skilled in the art, other drawings can be obtained based on the structures shown in these drawings without paying creative efforts.

FIG. 1 is a schematic structural diagram of a head-mounted device according to an embodiment of the present application.

FIG. 2 is a schematic structural diagram of a head-mounted device according to an embodiment of the present application.

FIG. 3 is a schematic structural diagram of a head-mounted device according to an embodiment of the present application.

FIG. 4 is a schematic structural diagram of a head-mounted device according to an embodiment of the present application from another viewing angle.

FIG. 5 is a schematic flowchart of a voice control module of a head-mounted device according to an embodiment of the present application.

FIG. 6 is a performance comparison curve diagram between the head-mounted device of the present application and the traditional solution.

The realization of the purpose, functional features and advantages of the present application will be further explained in conjunction with embodiments and with reference to the drawings.

### DETAILED DESCRIPTION OF THE EMBODIMENTS

The following will be combined with the drawings in the embodiments of the present application to clearly and completely describe the technical solutions in the embodiments of the present application. Obviously, the described embodiments are only part of the embodiments of the present application, not all of the embodiments. Based on the embodiments of the present application, all other embodiments obtained by persons skilled in the art without creative efforts are within the scope of protection of the present application.

It should be noted that if the embodiments of the present application involve directional indications (such as up, down, left, right, front, back, etc.), the directional indications are only used to explain the relative position relationship, movement status, etc. between the components under a certain specific posture (as shown in the drawings). If the specific posture changes, the directional indication will also change accordingly.

The terms “connection”, “installation”, “fixation” and the like should be understood in a broad sense. For example, “connection” can be a fixed connection, a detachable connection, or an integral connection; it can be a direct connection or an indirect connection through an intermediate medium. For persons skilled in the art, the specific meanings of the above terms in the present application can be understood according to specific circumstances.

In addition, if there are descriptions involving “first”, “second”, etc. in the embodiments of the present application, the descriptions of “first”, “second”, etc. are only used for descriptive purposes and cannot be understood as indicating or implying their relative importance or implicitly indicating the number of technical features indicated. Therefore, the features defined as “first” and “second” may explicitly or implicitly include at least one of the features. In addition, if the meaning of “and/or” appearing in the full text is to include three parallel schemes, taking “A and/or B” as an example, it includes scheme A, or scheme B, or a scheme that satisfies both A and B. In addition, the technical solutions between the various embodiments can be combined with each other, but it must be based on the ability of persons skilled in the art to implement. When the combination of technical solutions is contradictory or cannot be implemented, it should be deemed that such a combination of technical solutions does not exist and is not within the scope of protection required by the present application.

The present application provides a head-mounted device.

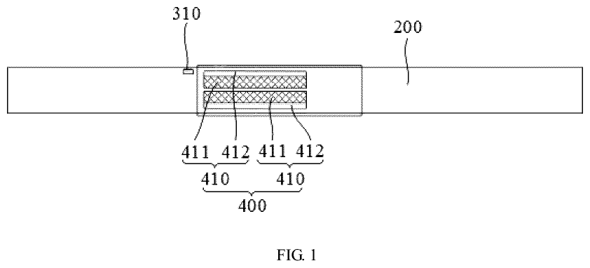

In an embodiment of the present application, as shown in FIG. 1 to FIG. 4, the head-mounted device includes a device body 100, a wearing portion 200, a bone conduction microphone 310 and a speaker module 400.

The wearing portion 200 is connected to an end of the device body 100. The bone conduction microphone 310 is provided at the wearing portion 200. The speaker module 400 is provided at the wearing portion 200 and includes two speaker units 410. Each speaker unit 410 includes a magnetic circuit structure 411, a voice coil and a sound diaphragm 412. At the first frequency band, the vibration directions of the sound diaphragms 412 of the two speaker units 410 are opposite.

It can be understood that when the head-mounted device is equipped with a bone conduction microphone 310, the shell of the head-mounted device vibrates, which will cause the voice input by the bone conduction microphone 310 to be mixed with the noise caused by the vibration of the shell. In the technical solution of the present application, in any frequency band or full frequency band of the speaker module 400, the vibration directions of the sound diaphragms 412 of the two speaker units 410 are opposite, which can make the force of the sound diaphragms 412 of the two speaker units 410 on the shell offset each other, thereby greatly reducing the intensity of mechanical vibration generated by the shell in the corresponding frequency band, which is conducive to the bone conduction microphone 310 picking up pure voice signals without environmental noise, so as to improve the voice quality input by the bone conduction microphone 310. In actual applications, a certain frequency band or full frequency band of the sound of the speaker module can be selected according to needs, and the desired effect of improving the voice quality can be achieved by making the vibration directions of the sound diaphragms 412 of the two speaker units 410 opposite.

Furthermore, in this embodiment, the first frequency band is a frequency band less than or equal to 300 Hz. In this frequency band, the mechanical vibration of the shell has a greater impact on the sound pickup signal-to-noise ratio of the bone conduction microphone 310. In this embodiment, by making the sound diaphragms 412 of the two speaker units 410 vibrate in opposite directions in a frequency band less than or equal to 300 Hz, the voice quality input by the bone conduction microphone 310 can be greatly improved. Furthermore, in the second frequency band greater than 300 Hz, the vibration directions of the sound diaphragms 412 of the two speaker units 410 are the same, so that the vibrations of the sound diaphragms 412 of the two speaker units 410 can be pushed against each other through the air of the rear sound cavity, which can reduce the distortion of the speaker module 400 and increase the external volume of the speaker module 400, so as to improve the sound quality of the speaker module 400. Moreover, in the second frequency band, the mechanical vibration of the shell has little effect on the sound pickup signal-to-noise ratio of the bone conduction microphone 310. The sound diaphragms 412 of the two speaker units 410 have the same vibration direction in the second frequency band. While improving the sound quality of the speaker module 400, it has almost no effect on the voice quality of the microphone input.

For the convenience of description, the dimension of the speaker module 400 in the distribution direction of the magnetic circuit structure 411 and the sound diaphragm 412 of the speaker unit 410 is called the thickness of the speaker module 400, and the dimension of the speaker module 400 in the extension direction of the sound diaphragm 412 is called the length of the speaker module 400. In addition, with reference to the state of the head-mounted device being worn on the human body, the dimension of the wearing portion 200 in the front-to-back direction is called its length, the dimension in the up-and-down direction is called its height, and the dimension in the left-to-right direction is called its thickness. Without loss of generality, in this embodiment, after the speaker module 400 is installed on the wearing portion 200, the thickness direction of the speaker module 400 is parallel to the thickness direction of the wearing portion 200, and the length direction of the speaker is parallel to the length direction of the wearing portion 200. In addition, it should be noted that the distribution direction of the magnetic circuit structure 411 and the sound diaphragm 412 of the speaker unit 410 refers to the direction from the magnetic circuit structure 411 to the sound diaphragm 412. The description of the relevant directions of the speaker unit 410 in this article is based on the state where the speaker unit 410 is installed on the wearing portion 200.

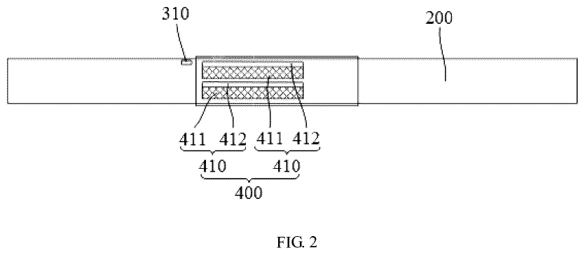

Furthermore, in this embodiment, as shown in FIG. 1 and FIG. 2, the distribution direction of the two speaker units 410 is parallel to the distribution direction of the magnetic circuit structure 411 and the sound diaphragm 412 of at least one of the speaker units 410. In order for the sound diaphragms 412 of the two speaker units 410 to be able to vibrate in opposite directions, it is necessary to make the distribution directions of the magnetic circuit structures 411 and the sound diaphragms 412 of the two speaker units 410 the same or opposite. The two speaker units 410 are divided along the distribution direction of the magnetic circuit structure 411 and the sound diaphragm 412 of at least one speaker unit 410, so that the axisymmetry of the speaker module 400 is better, and the sound consistency is better, which is conducive to improving the sound quality of the speaker module 400 and improving the weakening effect of the shell vibration.

Furthermore, in this embodiment, as shown in FIG. 1, the magnetic circuit directions of the magnetic circuit structures 411 of the two speaker units 410 are opposite. At the first frequency band, the voice coils of the two speaker units 410 are passed through in-phase currents, and in the second frequency band, the voice coils of the two speaker units 410 are passed through anti-phase currents. Since the distribution directions of the magnetic circuit structures 411 and the sound diaphragms 412 of the two speaker units 410 are the same, and the structures of the two speaker units 410 are set to be consistent, after they are installed on the wearing portion 200, the magnetic circuit directions of the magnetic circuit structures 411 of the two speaker units 410 can be the same. In this way, when installing the two speaker units 410, it is not necessary to distinguish different speaker units 410 and install them in different positions. It is only necessary to install the same speaker unit 410 in two installation positions with different installation directions, which is conducive to simplifying the bill of materials of the head-mounted device and improving the production and assembly efficiency of the head-mounted device. In other embodiments, after the two speaker units 410 being installed on the wearing portion 200, the magnetic circuit directions of the magnetic circuit structures 411 of the two speaker units 410 are the same. At this time, the voice coils of the two speaker units 410 pass anti-phase currents at the first frequency band and pass in-phase currents in the second frequency band, so that the sound diaphragms 412 of the two speaker units 410 can vibrate in opposite directions at the first frequency band and in the same direction in the second frequency band.

Furthermore, in this embodiment, as shown in FIG. 1, the magnetic circuit structures 411 and the sound diaphragms 412 of the two speaker units 410 are distributed in opposite directions, and the distribution direction of the two speaker units 410 is parallel to the distribution direction of the magnetic circuit structure 411 and the sound diaphragm 412 of one of the speaker units 410, and the sound diaphragms 412 of the two speaker units 410 are respectively arranged on opposite sides of the magnetic circuit structures 411 of the two speaker units 410. That is, the magnetic circuit structures 411 of the two speaker units 410 are arranged oppositely in the distribution direction of the magnetic circuit structures 411 and sound diaphragms 412 of the speaker units 410. In this way, the distribution direction of the two speaker units is parallel to the thickness direction of the speaker module 400, so that the thickness of the speaker module 400 is slightly larger, while the length can be effectively reduced, which is suitable for the situation where the layout in the length direction of the wearing portion 200 is cramped. The thickness can be appropriately increased at the corresponding position of the wearing portion 200 to meet the installation of the speaker module 400. In addition, the axisymmetry of the speaker module 400 is better, which is conducive to improving the sound consistency of the speaker module 400.

In other embodiments, as shown in FIG. 2, the distribution direction of the two speaker units 410, as well as the distribution direction of the magnetic circuit structure 411 and the sound diaphragm 412 of each speaker unit 410 are the same. The distribution direction of the magnetic circuit structure 411 and the sound diaphragm 412 of the speaker unit 410 refers to the direction from the magnetic circuit structure 411 to the sound diaphragm 412. In this embodiment, the distribution direction of the two speaker units is parallel to the thickness direction of the speaker module 400, so that the thickness of the speaker module 400 is slightly larger, while the length can be effectively reduced, which is suitable for the situation where the layout in the length direction of the wearing portion 200 is cramped. The thickness can be appropriately increased at the corresponding position of the wearing portion 200 to meet the installation of the speaker module 400.

Furthermore, in this embodiment, the magnetic circuit directions of the magnetic circuit structures 411 of the two speaker units 410 are the same. At the first frequency band, the voice coils of the two speaker units 410 are passed through anti-phase currents, and in the second frequency band, the voice coils of the two speaker units 410 are passed through in-phase currents. Since the distribution directions of the magnetic circuit structures 411 and the sound diaphragms 412 of the two speaker units 410 are the same, and the structural settings of the two speaker units 410 are consistent, after they are installed on the wearing portion 200, the magnetic circuit directions of the magnetic circuit structures 411 of the two speaker units 410 can be the same. In this way, when installing the two speaker units 410, it is not necessary to distinguish different speaker units 410 and install them in different positions. It is only necessary to install the same speaker unit 410 in the same installation direction at two installation positions, which is conducive to simplifying the bill of materials of the head-mounted device and improving the production and assembly efficiency of the head-mounted device. In other embodiments, after being installed in the wearing portion 200, the magnetic circuit directions of the magnetic circuit structures 411 of the speaker units 410 are opposite. At this time, the voice coils of the two speaker units 410 are passed through in-phase currents at the first frequency band and passed through anti-phase currents in the second frequency band, so that the sound diaphragms 412 of the two speaker units 410 can have opposite vibration directions at the first frequency band and the same vibration directions in the second frequency band.

Furthermore, in this embodiment, the wearing portion 200 is provided with two sound guiding channels (not shown) corresponding to the speaker module 400, one of the sound guiding channels corresponds to one of the speaker units 410, is communicated with the front sound cavity of the corresponding speaker unit 410, and is provided with a sound outlet hole communicated with the outside (not shown). The two speaker units 410 and the two sound guiding channels are symmetrical relative to the same symmetry axis. In this way, the axisymmetry of the speaker module 400 can be further improved, so that the sound consistency is better, which is conducive to further improving the sound quality of the speaker module 400 and improving the effect of weakening the vibration of the shell.

Furthermore, in this embodiment, the wearing portion 200 includes two side arms respectively connected to the two ends of the device body 100, and one of the side arms is correspondingly provided with a speaker module 400. In the related art, each of the two side arms is provided with a speaker, so that the two side arms are prone to mechanical vibration. In this embodiment, by providing a speaker module 400 on each of the two side arms, the user's auditory experience of wearing a head-mounted device is guaranteed. One speaker module 400 is provided with two speaker units 410. By making the sound diaphragms 412 of the two speaker units 410 vibrate in opposite directions within a certain frequency band, the mechanical vibration of the shell can be avoided as much as possible. Compared with the related art solution, the voice quality of the head-mounted device can be effectively improved.

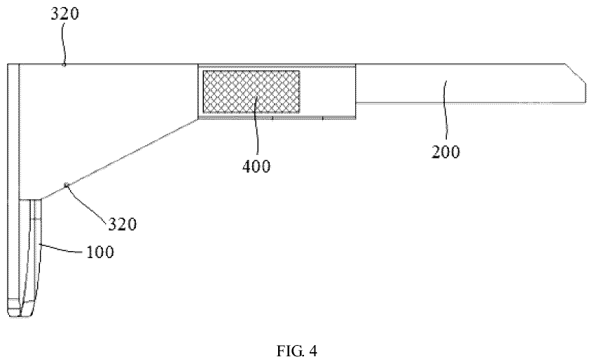

Furthermore, in this embodiment, as shown in FIG. 4, the head-mounted device further includes an air conduction microphone 320 provided on the wearing portion 200 and a voice control module (not shown) provided on the device body 100. The voice control module is configured to mix and process the voice signal of the air conduction microphone 320 and the voice signal of the bone conduction microphone 310. In this way, based on the voice signals collected by the air conduction microphone 320 and the bone conduction microphone 310 through different pathways, after the mixed processing of the voice control module, the obtained voice can be more in line with the human voice in the real environment, and can also achieve better noise reduction effect and better wind noise resistance, so that the uplink signal-to-noise ratio, echo performance and voice quality of the voice signal finally obtained are higher.

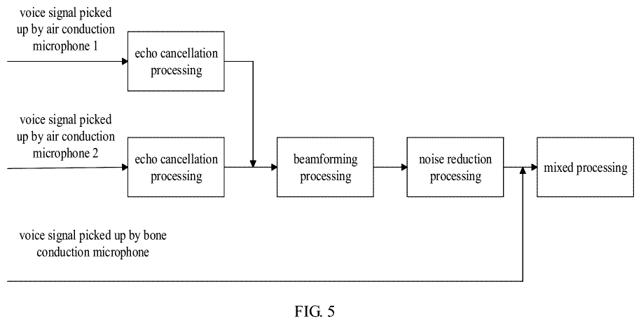

Specifically, the air conduction microphone 320 is provided at a side of the bone conduction microphone 310 close to the device body 100 to ensure the accuracy of the signal collection by the air conduction microphone 320 and the bone conduction microphone 310. Two air conduction microphones 320 are arranged, and the two air conduction microphones 320 are respectively arranged on the upper and lower sides of the same side arm. As shown in FIG. 5, the voice control module is configured to perform echo cancellation processing on the voice signal of each air conduction microphone 320, and perform beamforming processing on the voice signals of the two air conduction microphones 320 after the echo cancellation processing, and perform noise reduction processing on the air conduction voice signal formed after the beamforming processing, and mix the air conduction voice signal after the noise reduction processing with the voice signal of the bone conduction microphone 310.

The voice signals collected by the two air conduction microphones 320 both include human voice signals and environmental noise signals. The difference is that the human voice collection microphone is located at the lower side of the wearing portion 200, close to the user's mouth, so the proportion of human voice in the collected voice signal is relatively high. While the noise collection microphone is located on the upper side of the wearing portion 200 and is relatively far from the user's mouth, so the proportion of environmental noise in the collected voice signal is relatively high. In the echo cancellation processing of the voice control module, the speaker signals mixed in the environmental noise of the two air conduction microphones 320 can be filtered out respectively according to the downlink reference signal to ensure the echo cancellation effect. Then, the voice signals of the two air conduction microphones 320 after the echo cancellation processing are beamformed and noise reduction processed to further improve the voice quality of the air conduction microphones 320. Finally, the voice signals of the air conduction microphones 320 and the voice signals of the bone conduction microphones 310 are mixed and processed to obtain a relatively pure voice signal. The bone conduction microphone 310 picks up the voice signal conducted by the skull by coupling with the wearer's skull, and at the first frequency band, due to the reverse vibration of the diaphragms of the two speaker units 410, the speaker signal components picked up by the bone conduction microphone 310 are very small, so there is no need to perform echo cancellation processing, and the mixing processing can be performed directly.

The following three solutions are exemplified based on the inventive concept of the present application:

Solution 1: as shown in FIG. 1, the distribution directions of the magnetic circuit structures 411 and the sound diaphragms 412 of the two speaker units 410 are opposite, and the distribution directions of the two speaker units 410 are parallel to the distribution direction of the magnetic circuit structure 411 and the sound diaphragm 412 of one of the speaker units 410. The sound diaphragms 412 of the two speaker units 410 are respectively arranged on the opposite sides of the magnetic circuit structures 411 of the two speaker units 410. The magnetic circuit directions of the magnetic circuit structures 411 of the two speaker units 410 are the same. At a first frequency band less than or equal to 300 Hz, the sound diaphragms 412 of the two speaker units 410 vibrate in opposite directions. In a second frequency band greater than 300 Hz, the sound diaphragms 412 of the two speaker units 410 vibrate in the same direction.

Solution 2: as shown in FIG. 2, the distribution direction of the two speaker units 410, and the distribution direction of the magnetic circuit structure 411 and the sound diaphragm 412 of each speaker unit 410 are the same. The magnetic circuit direction of the magnetic circuit structure 411 of the two speaker units 410 is the same. At the first frequency band less than or equal to 300 Hz, the sound diaphragms 412 of the two speaker units 410 vibrate in opposite directions, and in the second frequency band greater than 300 Hz, the sound diaphragms 412 of the two speaker units 410 vibrate in the same direction.

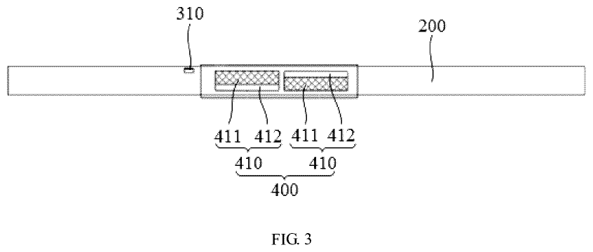

Solution 3: as shown in FIG. 3, the magnetic circuit structures 411 and the sound diaphragms 412 of the two speaker units 410 are distributed in opposite directions. The two speaker units 410 are arranged side by side in the distribution direction of the magnetic circuit structures 411 and the sound diaphragms 412 of the speaker units 410. The sound diaphragms 412 of the two speaker units 410 are respectively arranged on the adjacent sides of the opposite sides of the magnetic circuit structures 411 of the two speaker units 410. At the first frequency band less than or equal to 300 Hz, the sound diaphragms of the two speaker units 410 vibrate in opposite directions. In the second frequency band greater than 300 Hz, the sound diaphragms 412 of the two speaker units 410 vibrate in the same direction.

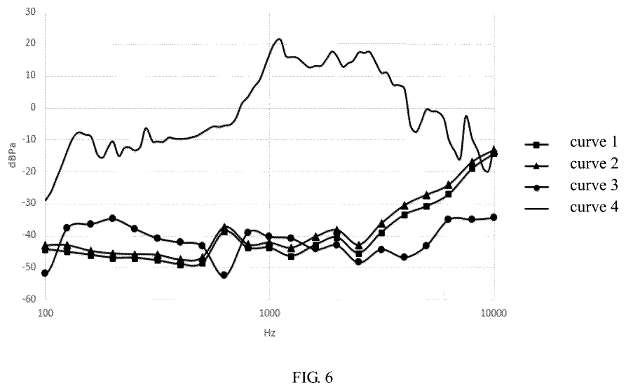

Please refer to FIG. 6, for the above three solutions, when the speaker is working at the maximum volume, the sound pressure of the interference signal from the speaker picked up by the bone conduction microphone 310 is shown as curves 1, 2, and 3 respectively. In addition, referring to the traditional solution, when a speaker is provided at each side of the wearing portion 200 of the head-mounted device, when the speaker is working at the maximum volume, the sound pressure of the interference signal from the speaker picked up by the bone conduction microphone 310 is shown as curve 4. As can be seen from FIG. 6, in the frequency band less than or equal to 300 Hz, the three solutions can achieve a noise reduction effect of more than 35 dB. Since the design of solution 1 is more symmetrical, the noise reduction effect is better.

The above descriptions are only optional embodiments of the present application, and are not intended to limit the patent scope of the present application. All equivalent structural changes made by using the contents of the specification and drawings of the present application under the inventive concept of the present application, or directly/indirectly applied in other related technical fields are included in the patent protection scope of the present application.

What is claimed is:

1. A head-mounted device, comprising:
a device body;
a wearing portion connected to an end of the device body;
a bone conduction microphone provided at the wearing portion; and
a speaker module provided at the wearing portion,
wherein the speaker module comprises two speaker units;
each speaker unit comprises a magnetic circuit structure, a voice coil and a sound diaphragm;
a distribution direction of the two speaker units is parallel to a distribution direction of the magnetic circuit structure and the sound diaphragm of at least one of the speaker units; and
vibration directions of the sound diaphragms of the two speaker units are opposite at a first frequency band.

2. The head-mounted device according to claim 1, wherein magnetic circuit directions of the magnetic circuit structures of the two speaker units are opposite, and the voice coils of the two speaker units are passed with in-phase current at the first frequency band.

3. The head-mounted device according to claim 1, wherein the distribution directions of the magnetic circuit structures and the sound diaphragms of the two speaker units are opposite, the distribution directions of the two speaker units are parallel to the distribution direction of the magnetic circuit structure and the sound diaphragm of one of the speaker units, and the sound diaphragms of the two speaker units are respectively provided at opposite sides of the magnetic circuit structures of the two speaker units.

4. The head-mounted device according to claim 3, wherein the wearing portion is provided with two sound guiding channels corresponding to the speaker module;
one sound guiding channel corresponds to one speaker unit, is communicated with a front sound cavity of the corresponding speaker unit, and is provided with a sound outlet hole communicated with outside; and
the two speaker units and the two sound guiding channels are symmetrical relative to a same symmetry axis.

5. The head-mounted device according to claim 1, wherein the wearing portion comprises two side arms respectively connected to two ends of the device body, and one side arm is correspondingly provided with one speaker module.

6. The head-mounted device according to claim 1, further comprising:
two air conduction microphones respectively provided at an upper side and a lower side of the same side arm.

7. The head-mounted device according to claim 6, wherein the air conduction microphone is provided at a side of the bone conduction microphone close to the device body.

8. The head-mounted device according to claim 1, wherein the first frequency band is a frequency band less than or equal to 300 Hz, and the vibration directions of the sound diaphragms of the two speaker units are identical at a frequency band greater than 300 Hz.

9. The head-mounted device according to claim 1, further comprising:
an air conduction microphone provided at the wearing portion; and
a voice control module provided at the device body,
wherein the voice control module is configured to perform mixed processing on voice signals of the air conduction microphone and the bone conduction microphone.

10. The head-mounted device according to claim 9, wherein there are multiple air conduction microphones, and the voice control module is configured to perform echo cancellation processing on the voice signal of each air conduction microphone, perform beamforming processing on the voice signals of the multiple air conduction microphones after the echo cancellation processing, perform noise reduction processing on an air conduction voice signal formed after the beamforming processing, and mix the air conduction voice signal after the noise reduction processing with the voice signal of the bone conduction microphone.

11. The head-mounted device according to claim 10, wherein two air conduction microphones are provided, and are respectively provided at an upper side and a lower side of the wearing portion.
